(19) United States
(12) Patent Application Publication
(10) Pub. No.: US 2026/0300928 A1
(43) Pub. Date: Oct. 1, 2026

(54) AGENT FOR HOSTING AND FACILITATING VIRTUAL MEETING

(71) Applicant: INTERNATIONAL BUSINESS MACHINES CORPORATION, Armonk, NY (US)

(72) Inventors: Rui Han, Xi'an (CN); Yuan Yuan Ding, Shanghai (CN); Qi Liang Zhou, Xian City (CN); Zhong Fang Yuan, Xi'an (CN); Heng Cheng Ke, DaYe (CN)

(21) Appl. No.: 19/089,523

(22) Filed: Mar. 25, 2025

(51) Int. Cl. G06Q 10/1093; G06N 20/00

(52) U.S. Cl. CPC G06Q 10/1093; G06N 20/00

(57) ABSTRACT

A method includes initializing an artificial intelligence (AI) agent configured to host and facilitate meetings; and integrating the AI agent with one or more external tools. Responsive to a request to host and facilitate a meeting, the AI agent generates meeting details including a meeting topic, participants, and a start time. The AI agent using a generative machine learning model generates a meeting plan based on the request. The AI agent executes the meeting plan by interacting with meeting participants using natural language processing, accessing relevant information from the one or more external tools, and updating meeting-related data using the one or more external tools. The AI agent using the generative machine learning model generates a meeting summary based on the executed meeting plan.

### BACKGROUND

The present invention generally relates to agents for large language models (LLM) and more particularly to systems and methods which can employ an automated agent for hosting and facilitating complex tasks.

### SUMMARY

In accordance with an embodiment of the present invention, a computer-implemented method includes initializing an artificial intelligence (AI) agent configured to host and facilitate meetings; and integrating the AI agent with one or more external tools. Responsive to a request to host and facilitate a meeting, the AI agent generates meeting details including a meeting topic, participants, and a start time. The AI agent using a generative machine learning model generates a meeting plan based on the request. The AI agent executes the meeting plan by interacting with meeting participants using natural language processing, accessing relevant information from the one or more external tools, and updating meeting-related data using the one or more external tools. The AI agent using the generative machine learning model generates a meeting summary based on the executed meeting plan.

In accordance with another embodiment of the present invention, a system includes a processor set, one or more computer-readable storage media and program instructions stored on the one or more computer-readable storage media to cause the processor set to perform operations. The operations include initializing an artificial intelligence (AI) agent configured to host and facilitate meetings; integrating the AI agent with one or more external tools; responsive to a request to host and facilitate a meeting, generating, by the AI agent, meeting details including a meeting topic, participants, and a start time; generating, by the AI agent using a generative machine learning model, a meeting plan based on the request; and executing, by the AI agent, the meeting plan by: interacting with meeting participants using natural language processing, accessing relevant information from the one or more external tools, and updating meeting-related data using the one or more external tools; and generating, by the AI agent using the generative machine learning model, a meeting summary based on an executed meeting plan.

In accordance with another embodiment of the present invention, a computer program product includes one or more computer-readable storage media; and program instructions stored on the one or more computer-readable storage media to perform operations. The operations include initializing an artificial intelligence (AI) agent configured to host and facilitate meetings; integrating the AI agent with one or more external tools; responsive to a request to host and facilitate a meeting, generating, by the AI agent, meeting details including a meeting topic, participants, and a start time; generating, by the AI agent using a generative machine learning model, a meeting plan based on the request; and executing, by the AI agent, the meeting plan by: interacting with meeting participants using natural language processing, accessing relevant information from the one or more external tools, and updating meeting-related data using the one or more external tools; and generating, by the AI agent using the generative machine learning model, a meeting summary based on an executed meeting plan.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block/flow diagram showing an artificial intelligence (AI) agent accessing a task board, team, and external tools to host and facilitate a meeting or other activity, in accordance with an embodiment of the present invention;

FIG. 2 is a block/flow diagram showing the AI agent employing a meeting application programming interface (API) to create, message, host and update tasks in a meeting or other activity, in accordance with an embodiment of the present invention;

FIG. 3 shows a program to define an AI agent, in accordance with an embodiment of the present invention;

FIG. 4 is program code to create a meeting API, in accordance with an embodiment of the present invention;

FIG. 5 is program code for a send message API, in accordance with an embodiment of the present invention;

FIG. 6 is program code for a host meeting API, in accordance with an embodiment of the present invention;

FIG. 7 is a concept diagram and a block/flow diagram showing data objects and their relationships for a project management tool implemented in accordance with an embodiment of the present invention;

FIG. 8 is a concept diagram and a block/flow diagram showing data objects and their relationships updated for a project management tool, in accordance with an embodiment of the present invention;

FIG. 9 is a block diagram showing a computer environment for hosting and facilitation of activities using an AI agent and an LLM, in accordance with an embodiment of the present invention; and

FIG. 10 is a flow diagram showing methods for hosting and facilitation of activities using an AI agent and an LLM, in accordance with an embodiment of the present invention.

### DETAILED DESCRIPTION

Large language models (LLMs) are generative machine learning models and have demonstrated remarkable capabilities in various applications, from natural language processing to task automation. Current implementations of LLM-based agents often focus on specific use cases or narrow domains. While progress has been made, there remains potential for broader applications, e.g., in project management and task coordination. Existing solutions do not fully address the challenges of integrating LLM capabilities with real-time project tracking, team collaboration, and adaptive task prioritization.

In accordance with embodiments of the present invention, a system and method for hosting and facilitating computer tasks using large language model (LLM) agents are provided. The system can include an LLM-based artificial intelligence (AI) agent configured to act as a virtual host for various project management activities, such as, e.g., SCRUM™ meetings. In some embodiments, the LLM-based AI agent (or LLM agent) can autonomously create and manage meetings, send invitations to participants, and facilitate discussions during the meeting.

The AI agent can integrate with existing project management tools and application program interfaces (APIs) to access and update task information in real-time. In some cases, the agent may utilize speech-to-text and text-to-speech capabilities to interact with meeting participants, permitting seamless communication between the virtual host and human team members.

The system can incorporate a knowledge base and set of rules that enable the agent to prioritize tasks, manage speaking order, and summarize key points from discussions. In some implementations, the agent may use an “Urgent-Important Matrix” or similar prioritization techniques to organize tasks and guide the meeting flow. Additionally, the AI agent may be capable of generating meeting summaries, updating task statuses, and providing follow-up actions to team members. The system can also handle absence management and adjust meeting schedules as needed.

In some embodiments, the AI agent can extend beyond SCRUM™ meetings to facilitate other types of project-related activities, such as code reviews, brainstorming sessions, or status updates. The AI agent may adapt its behavior based on the specific context and requirements of each meeting type. The system can also include mechanisms for continuous learning and improvement, allowing the AI agent to refine its hosting and facilitation skills over time based on feedback and outcomes from previous meetings.

The AI agent can be rapidly applied across various fields, helping users break free from daily tasks and repetitive labor, reducing human workload, and increasing task-solving efficiency. Instructions can autonomously analyze, plan, and solve problems. The AI agent can host or manage procedural activities, guiding them according to specific rules, and these rules could often be replaced. For example, in a daily meeting, a SCRUM™ master can follow the planned tasks on a board, communicating sequentially with the project leads to understanding the project's progress and organizing discussions to resolve issues.

A SCRUM™ project is used herein as an example to describe how an agent can act as a host to provide hosting and facilitation functionality. A meeting artificial intelligence agent can be composed of four parts: tools, brain (such as a generative machine learning model), memory, and planning. In this scenario, consider the interfaces corresponding to the board, each team member, and external tools as resources that the agent can call upon as tools. In an embodiment, a development meeting host plan can be employed based on a meeting API. The meeting API and task arrangement APIs can be employed to automate the hosting of development meetings, record all task information, and coordinate updates with the task board.

The AI agent, in this example, can automatically generate and facilitate at least the following tasks: 1) create a meeting, 2) send meeting information to participants and 3) host the meeting.

The meeting can be set up using the meeting API, which can configure relevant permissions, including defining the meeting topic (e.g., daily project development meeting), participants, meeting time, meeting location, associated task boards, etc. Sending the meeting information to participants can include distributing the meeting details to participants and confirming a number of attendees as well as their responses (RSVPs). Hosting the meeting can include prioritizing the meeting tasks, e.g., employing the “Urgent-Important Matrix” (or “Eisenhower Matrix”) to categorize and prioritize the tasks. Hosting can include planning a speaking order for participants based on the task prioritization. According to user IDs (from the meeting API), the meeting agent can designate the speaking order for each participant.

After a user or participant finishes speaking, their speech (using, e.g., a multimodal LLM to convert speech to text and record the text) can be summarized. Then, the meeting agent can designate a next speaker. If, during the meeting, a user needs a response from the host, or another user needs to add information, the meeting agent responds, or the other user continues to provide further details. The meeting agent then summarizes the additional information. This summarizing can be done by using an LLM to convert the agent's generated text into speech, providing a real-time response. Once the user has finished describing the task, the meeting agent uses task-related tools to update the task panel's status. At the end of the meeting, a meeting summary can be generated and sent to inform a client about the next steps and define a process for handling any absences.

KANBAN™ is an agile project management tool that helps visualize work, limit work in progress, and maximize efficiency (or flow). KANBAN™ uses cards, columns, and visual progress management on a user interface displayed on a display screen of a computer to help teams deliver a well-planned workload on time. KANBAN™ tools often include management units such as Sprints, Backlogs, Issues (or Bugs), To-do Tasks, and Groups.

In an embodiment, an artificial intelligence (AI) agent in accordance with embodiment of the preset invention achieves automated project management by manipulating specific properties of objects in the KANBAN™ system. To enable the AI agent to automate the management of objects in KANBAN™, relevant tools for different management units are defined based on their operational characteristics. Additionally, the AI agent is provided with a project management rules knowledge base. Using one or more LLM models, specific steps to achieve a given goal are planned out, and ultimately, an agent_executor module within the AI agent can call corresponding tool APIs (e.g., update_status_task and append_comment_task.) to carry out these steps. Other external software tools are also included in other embodiments.

In some embodiments, the system is based on a LLM and can instantly understand and analyze conversation content. The system is able to automatically call third-party tools to update task status, and an extended prompt generator can generate a pseudo SQL (Structured Query Language) prompt to improve accuracy. The meeting agent can automatically schedule meetings, summarize meeting minutes and/or extract key points. The system provides enhanced efficiency and productivity and leverages LLMs to automate various tasks, such as scheduling meetings, sending reminders, and generating meeting agendas, freeing up human facilitators to focus on more strategic aspects.

In some embodiments, the systems and methods for hosting and facilitating meetings using an AI agent provides technical improvements to computer technology and automated meeting management. The AI agent, when implemented on one or more processors, enhances the functionality of computer systems by dynamically integrating large language models with external tools and APIs to automate complex meeting workflows. This integration allows for real-time natural language processing of meeting conversations, automated task prioritization, and intelligent updating of project management tools, which are not practical for human meeting facilitators to perform manually.

In some embodiments, the system leverages specialized data structures and algorithms to efficiently process and analyze meeting data, improving the speed and accuracy of meeting management tasks. For example, the AI agent utilizes optimized natural language processing techniques to convert speech to text in real-time, applies machine learning models to extract key information from conversations, and/or uses graph-based data structures to track and update task dependencies across multiple project management tools concurrently.

Furthermore, the technical solution provided by the AI agent addresses challenges in distributed computing environments, such as coordinating meeting activities across multiple time zones, integrating heterogeneous data sources, and ensuring data consistency across various cloud-based services. In some embodiments, the system employs novel synchronization protocols and data caching mechanisms to maintain low-latency performance even when processing large volumes of meeting-related data from diverse sources.

By automating and optimizing these complex computational tasks, the system reduces project management complexities which can plague human participants, potentially leading to more efficient and productive meetings. This technical approach goes beyond mere automation of meetings, instead providing a transformative solution that leverages advanced computing capabilities to enhance collaborative workflows in ways not previously possible with other systems.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content-such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes, in some instances, imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch.

Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—a hundred times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of MICROSOFT™. Other examples include META™'s Llama models and GOOGLE™'s bidirectional encoder representations from transformers (BERT/RoBERTa) and PaLM models. IBM™ has also recently launched its Granite model series on watsonx. ai, which has become the generative AI backbone for other IBM™ products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to billions of parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a massive corpora of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they've acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants (like IBM™ watsonx Assistant and GOOGLE™'s BARD) to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

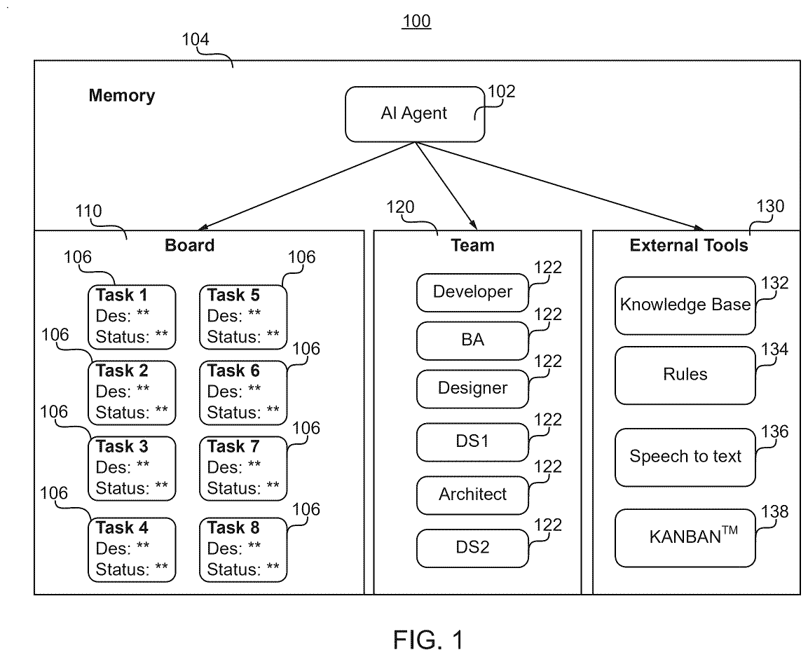

Referring now to the drawings in which like-numerals represent the same or similar elements and initially to FIG. 1, an architecture of an agent system 100 is illustrated for managing SCRUM™ projects in accordance with an example embodiment of the present invention. An agent or AI agent 102, which can be stored in non-transitory memory or memory 104, serves as a central hub for coordinating various project management activities. The AI agent 102 hosts, coordinates, and facilitates interactions between a plurality of different entities. In this example, the entities include a board 110, a team 120 and external tools (e.g., tool APIs 130). Additional entities instead of or in addition to those depicted are also contemplated.

The board 110 includes a representation of project tasks, showing a plurality of tasks 106 (e.g., Task 1 through Task 8). Each task 106 can include associated details (e.g., descriptions (des.) and status indicators (e.g., status), allowing for quick assessment of project progress. Any number of tasks 106 can be provided. The tasks 106 can be added and removed as needed. The AI agent 102 can dynamically update the program progress in real-time evaluating changes on-the-fly, which would be impossible for project managers to perform manually.

The team 120 represents lists of several key roles 122 that can be found in a SCRUM™ project, including, e.g., a Developer, BA (Business Analyst), Designer, Data Scientist 1 (DS1), Architect, and Data Scientist 2 (DS2). This structure facilitates role-based task assignment and communication within a project team. DS1 and DS2 can refer to different levels or specializations of Data Scientists within the SCRUM™ project management team. For example, DS1 can represent a junior or mid-level data scientist role, and DS2 can indicate a senior-level data scientist or a data scientist with a different specialization compared to DS1.

The external tool, such as a tool API 130, encompasses several components that enhance the capabilities of the AI agent 102. For example, a knowledge base 132 can store project-related information, best practices, and historical data. Rules 134 can define operational guidelines and constraints for the AI agent 102. Speech to text 136 (and text to speech) can enable voice interaction and transcription capabilities. Project management methodologies 138, such as, e.g., KANBAN™ or other tool or tools, can be integrated into the system 100 for use by the AI agent 102.

The AI agent 102 has the ability to retain and utilize information across different project phases and interactions. The interconnected nature of these components permits the AI agent 102 to seamlessly coordinate tasks, team roles, and external tools. This integration allows for efficient project management by connecting various resources under a single agent. In some embodiments, the AI agent 102 employs the architecture of the system 100 to automate aspects of SCRUM™ project management, such as task allocation, progress tracking, and meeting facilitation. The system 100 can adapt to project needs by leveraging its knowledge base 132, applying predefined rules 134, and utilizing other external tools as needed.

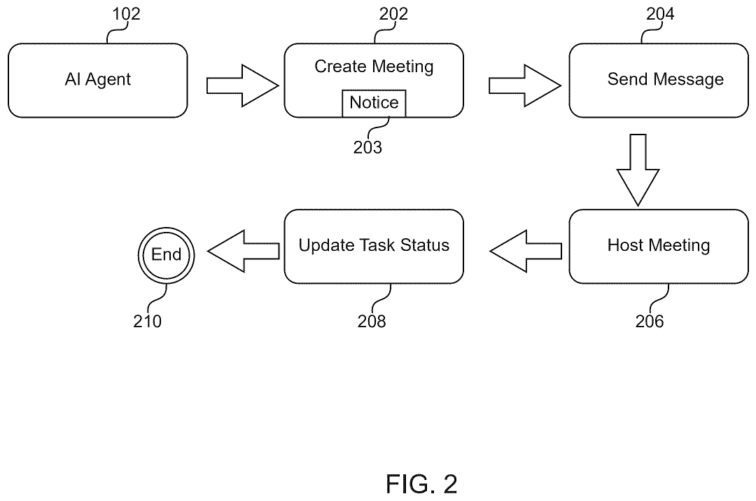

Referring to FIG. 2, a block/flow diagram shows the system 100 orchestrating an entire meeting process, from task prioritization to participant interactions and task status updates. The system 100 leverages sub-functions to handle specific aspects of the meeting, ensuring a comprehensive and efficient virtual meeting. In block 202, the AI agent 102 develops a meeting host plan based on one or more meeting APIs. The meeting APIs can be selected from a collection of meeting APIs or an API or APIs can be customized by the AI agent 102.

In an embodiment, the meeting API can be customized with participant preferences, equipment availability, coordinate calendars, etc. As an example, the AI agent 102 can send a notice object 203 to participants or potential participants to collect information about meeting preferences (e.g., times, dates, locations, etc.), to identify participants (e.g., ask whether all pertinent parties have been identified), to identify equipment capabilities (e.g., do all participants have audio?, visual?, input and output capabilities?, etc.), to determine meeting goals topics, etc. The meeting APIs and task arrangement APIs can be employed to automate the hosting of development meetings, record all task information, and coordinate updates with the task board 110 (FIG. 1).

In block 202, the AI agent 102 sets up the meeting API (application) and configures the relevant permissions, including, e.g., defining the meeting topic (e.g., daily project development meeting), participants, meeting time, meeting location, associated task boards, participant preferences, participant capabilities, etc.

In block 204, meeting information (e.g., a message or messages) is sent to the participants. This can include distributing the meeting details to participants and confirming the number of attendees as well as their responses.

In block 206, the meeting is hosted by the AI agent 102. The AI agent 102 can categorize and prioritize meeting tasks. In an embodiment, the AI agent 102 can interact with an “Urgent-Important Matrix” or “Eisenhower Matrix” or similar time management and prioritization tools. The Urgent-Important Matrix or Eisenhower Matrix categorizes tasks into four quadrants based on their urgency and importance, helping individuals focus on what truly matters. The matrix can divide tasks into an urgent and important quadrant with tasks that need immediate attention and need to be addressed first. An important but not urgent quadrant includes tasks that are crucial for long-term goals and need to be scheduled and prioritized. An urgent but not important quadrant includes tasks that are often distractions and can be delegated or minimized. A neither urgent nor important quadrant includes tasks that are often time-wasting and need to be eliminated or delegated. Other prioritization mechanisms can also be employed.

The AI agent 102 can plan the speaking order for participants based on the task prioritization. According to the user IDs (from the meeting app), the AI agent 102 can designate the speaking order for each participant. The AI agent 102 can monitor the discussion and determine whether the speaker is going off-topic or taking an inordinate amount of speaking time. The AI agent 102 can politely interrupt and interject a notification, such as, e.g., “while interesting, I am not certain this in furtherance of the task being considered” or “it may be appropriate for the next participant to contribute at this time”.

After a participant finishes speaking, their speech can be summarized, e.g., using a multimodal LLM to convert speech to text and record the speech as textual and/or audio data. Then, the AI agent 102 can designate a next speaker. If, during the meeting, a participant needs a response from the AI agent 102 host, or another user needs to add information, the AI agent 102 responds or the other user continues to provide further details. The AI agent then summarizes the additional information. This is done in an embodiment by using the LLM to convert the agent's generated text into speech, providing a real-time response and verbal interaction. The speech is audio data that is played over a microphone connected to a computer and/or transmitted to be played at other computers.

In block 208, the AI agent 102 can update the task status in accordance with the meeting discussions. The AI agent 102 can perform this and update downstream tasks dynamically. The AI agent 102 can not only update tasks but can update contingent tasks, reevaluate dates, consider rules associated with the tasks and execute the rules to properly recategorize, update and output current information project wide. Once a participant has finished addressing a task, the AI agent 102 can employ task-related tools to update the task's panel status.

In block 210, at the end of the meeting, the AI agent 102 can send a meeting summary, inform a client about the next steps, and/or define a process for handling any absences or unaddressed issues. The AI agent 102 can close the meeting. The meeting can be closed with the generation of action items, next steps, follow-up meeting suggestions, all handled by the AI agent 102.

Once the AI agent 102 is associated with the architecture in FIG. 1 and has access to the LLM, the AI agent 102 can be prompted to carry out hosting and facilitating activities. For example, the hosting task of FIG. 2 can be performed, e.g., using the following prompt: “You are the meeting host. Please follow the normal meeting hosting process to arrange the meeting: 1. Create a meeting, including {meeting topic}, {participant list}, {meeting start time}, etc.; 2. Send the meeting information created in step 1 to the participants; 3. Host meetings, including sorting tasks, specifying the order in which participants will speak, responding to relevant questions from participants, and summarizing tasks; 4. Follow the new task panel.” While illustrative, this prompt can be enhanced and fine-tuned to provide additional functionality as needed. The prompt is input into the AI agent 102 to cause the AI agent 102 to carry out the instructions that are in the prompt.

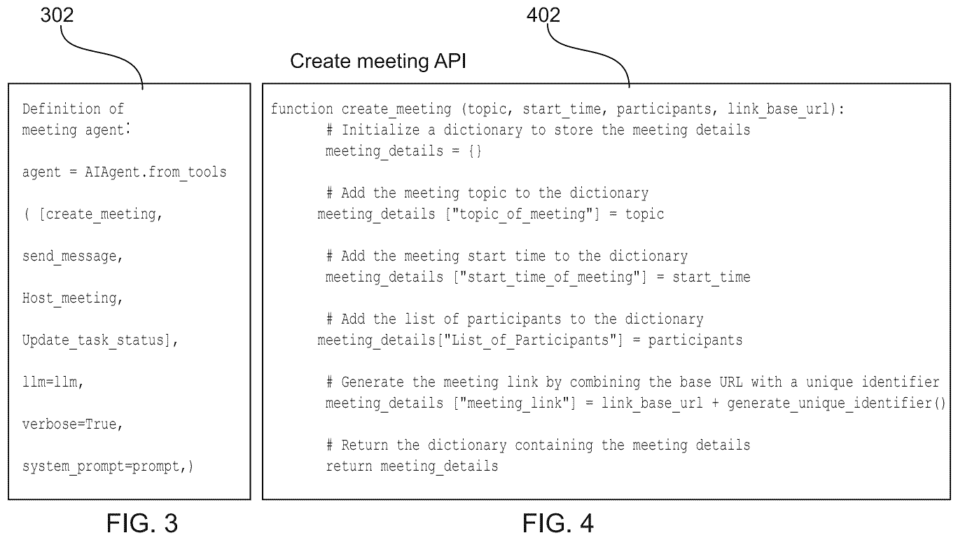

Referring to FIG. 3, program code 302 for defining a meeting agent (e.g., AI agent 102) and associating an LLM is shown. The program code 302 includes calling a number of enumerated tasks (e.g., agent=AIAgent. from tools ([tasks])). In Python, setting verbose=True enables a more detailed output or logging during the execution of a function or process.

Referring to FIG. 4, program code for a create meeting API 402 (see block 202, FIG. 2) is shown in accordance with an embodiment. The meeting API calls a function create_meeting, which sets up the meeting and a dictionary for meeting details and meeting links. The create meeting API 402 initializes and sets up a new meeting within the system 100. The create meeting API 402 handles initializing a meeting details dictionary, sets meeting topics, sets meeting start time, adds a list of participants and generates a unique meeting link.

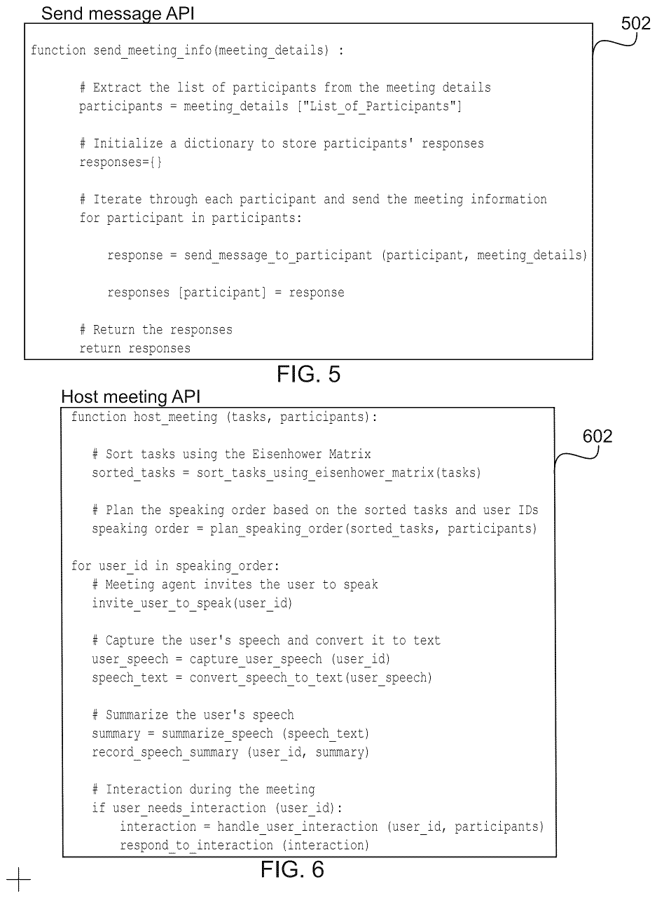

Referring to FIG. 5, program code for a send message API 502 (see block 204, FIG. 2) is shown in accordance with an embodiment. The send message API calls a function send_meeting_info, which is responsible for distributing meeting details to all participants. This send message API 502 handles the following functionalities: creates a dictionary to store participant responses, iterates through each participant to send meeting information to each participant and collects responses from the participants.

Referring to FIG. 6, program code for a host meeting API 602 (see block 206, FIG. 2) is shown in accordance with an embodiment. The host meeting API calls a function host_meeting, which is responsible for managing live meeting interactions within the system 100. The host meeting API 602 handles the following functionalities: sorts tasks using a priority matrix, plans speaking order based on sorted tasks and user IDs, manages participant interactions, converts speech to text, summarizes discussions and updates task statuses.

In the realm of large language models (LLMs), application programming interfaces (APIs) act as translators, allowing seamless exchange between LLMs and artificial intelligence (AI) applications. These interfaces facilitate the integration of natural language processing (NLP) and natural language understanding capabilities into software systems.

LLM APIs are typically based on a request-response architecture that follows a series of steps:
1. An application sends a request—generally in the form of a hypertext transfer protocol (HTTP) request—to the API. Before transmission, the app first converts the request into the API's required data format (usually in JavaScript Object Notation or JSON), which contains information such as the model variant, the actual prompt and other parameters.
2. After the API receives the request, it forwards it to the LLM for processing.
3. The machine learning model (LLM) draws upon its NLP skills—be it content generation, question answering, sentiment analysis, text generation and/or text summarization—to produce a response that it relays to the API.
4. The API delivers this response back to the application.

In at least some present embodiments, the application is the LLM agent/AI agent 102.

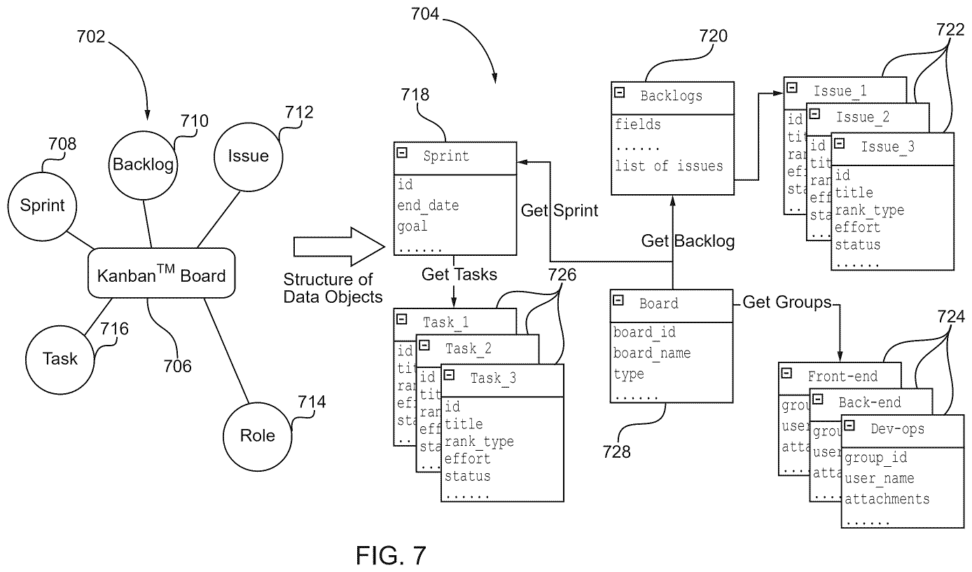

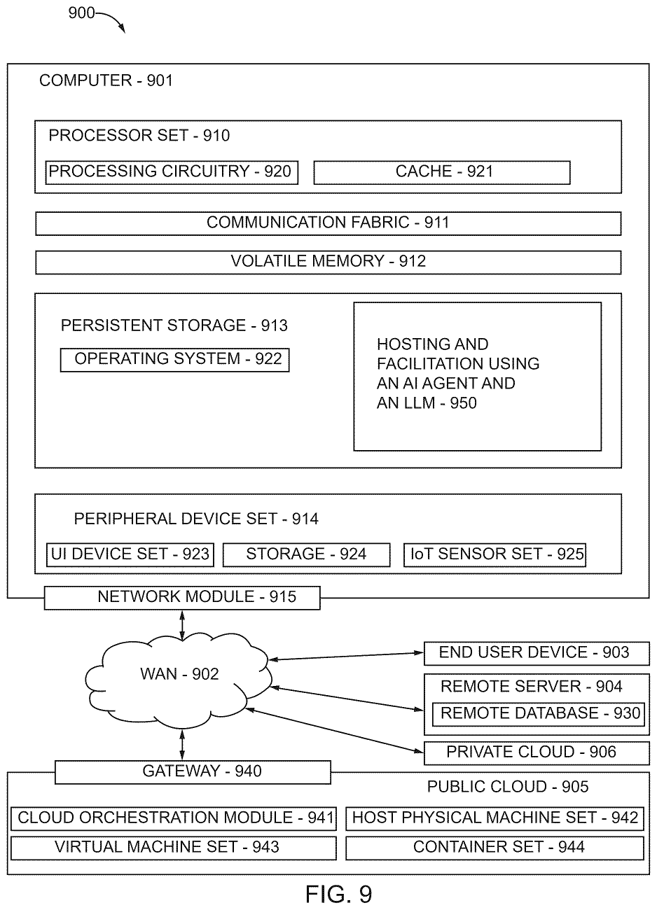

Referring to FIG. 7, in some embodiments, the AI agent 102 can be integrated with project management tools. In one example, the present embodiments can employ programs, such as e.g., KANBAN™. KANBAN™ is an agile project management tool that helps visualize work, limit work in progress, and maximize efficiency (or flow). KANBAN™ uses cards, columns, and visual progress management on a user interface displayed on a display screen of a computer such as the computer 901 shown in FIG. 9 to help teams deliver a well-planned workload on time. KANBAN™ tools can include objects or management units such as Sprints, Backlogs, Issues (or Bugs), To-do Tasks, and Groups. The AI agent 102 achieves automated project management by manipulating specific properties of the objects or management units in the KANBAN™ system.

A conceptualized diagram 702 shows data attributes and relationships of different management units within the KANBAN™ system. Here, the management units include sprints 708, backlogs 710, issues 712 (or bugs), roles 714 (or groups) and tasks 716. A sprint is a short, time-boxed period within a project where a team focuses on completing a specific set of tasks to achieve a defined goal. Sprint is used in agile methodologies where work is broken down into manageable chunks to deliver results quickly and iteratively. Backlogs, issues, roles, tasks, etc. are employed in a same way as used in agile methodologies.

A diagram 704 shows structured data objects within the KANBAN™ system corresponding to the attributes and relationships of the conceptualized diagram 702. Sprint objects 718 can include identification information, end date information, a goal, etc. Backlog objects 720 can include issue fields, lists of issues, etc. Issue objects 722 can include identification information, title, ranking type, effort, status, etc. Role or group objects 724 can include group ids, usernames, attachments for front end, backend and dev ops (development and operation teams), etc. Board objects 728 can include board ids, board names, types, etc. Task objects 726 can include task id, title, rank types, effort, status, etc.

The KANBAN™ project management tool can be integrated with the AI agent 102. The AI agent 102 can employ the structure, data and operations of the KANBAN™ architecture to host and facilitate, meetings, negotiations and other processes in accordance with embodiments of the present invention.

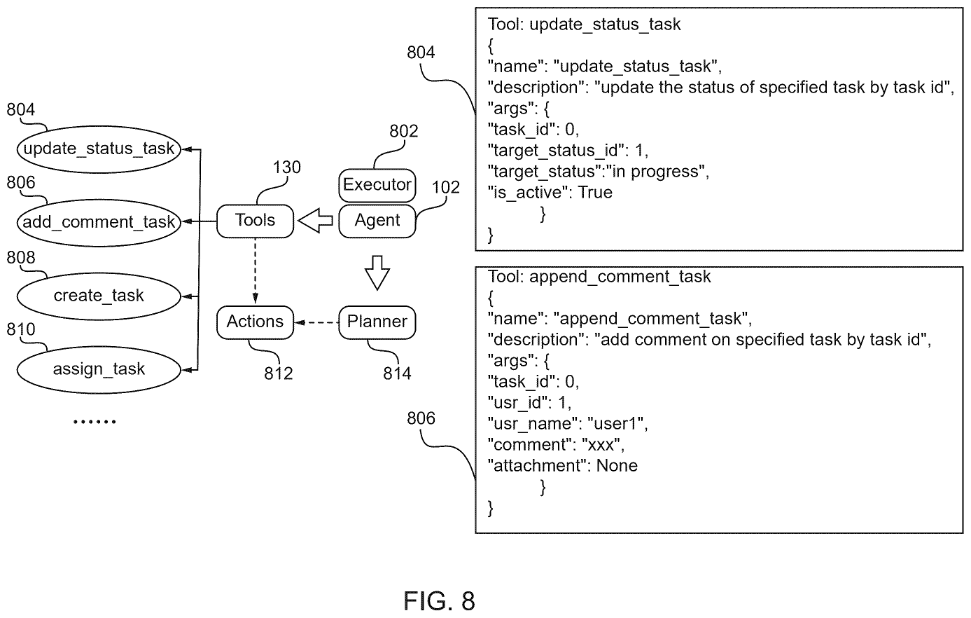

Referring to FIG. 8, to enable the AI agent 102 to automate the management of objects in KANBAN™, relevant tools (e.g., tool APIs 130) need to be defined for different management units based on their operational characteristics. Additionally, the AI agent 102 is provided with a project management rules knowledge base 132 (FIG. 1). Using LLM models, specific actions 812 to achieve a given goal are planned out by a planner 814, and ultimately, an agent_executor module 802 within the AI agent 102 can call the corresponding tool APIs 130, for corresponding functions. The planner 814 is a generative artificial intelligence (AI) assistant that is trained to participate in a planning and decision-making process.

The tool APIs 130 are configured to be accessible by and work with the AI agent 102 to host and facilitate project related activities including project status updates, meetings, contract negotiations, etc. The AI agent 102 can be prompted and then automatically handle hosting responsibilities and logistics in an organized and efficient manner. The AI agent 102 can use the power of LLMs to reconfigure management units of the KANBAN™ system or other external APIs to provide the hosting and facilitating functions in accordance with embodiments of the present invention.

In an example, FIG. 8 shows a plurality of external tools. The tools can include, but are not limited to update_status_task 804, append_comment_task 806, create_task 808, assign_task 810, etc. The update_status_task 804 and append_comment_task 806 are illustratively shown in greater detail. The update_status_task 804 and append_comment_task 806 list definitions and parameter information for these tools.

The tools, and more specifically the update_status_task 804 and append_comment_task 806 tools, are defined for use by the AI agent 102. By defining these tools, the AI agent 102 can employ their functions to permit the hosting and facilitating actions.

During execution, the AI agent 102 can draw on the external tools and the functionality of the LLM such that the AI agent 102 is a virtual agent that integrates the functions and abilities of different tools to create an ensemble architecture to carry out prompted activities of a user.

The AI agent 102 can rely on LLMs to enhance the calling of external tools and to translate code of existing tools to serve needed functions in accordance with the present embodiments. While the AI agent 102 can employ any neural network, in accordance with an embodiment, the AI agent 102 can employ a transformer architecture or transformer-based machine learning model or, simply, transformer. An input to the transformer can represent initial code or data that needs to be translated. This input can be in any programming language and is fed into an encoder of the transformer, initiating the translation process. Multiple transformer layers within the encoder systematically process the input. Each layer applies self-attention mechanisms to understand the context within the input sequence and generate a state that captures the nuances of the source code. A state is an encoded version of the input, enriched with contextual information that flows from the encoder to the decoder. This state serves as a comprehensive representation of the source code, carrying all necessary information for accurate translation.

A decoder includes its own stack of transformer layers, takes the state and begins the process of generating the translated code. These layers are similar to the encoder layers but also include cross-attention mechanisms that focus on different parts of the input sequence based on the current output. An output can include final translated code, external tool identities, modifications to code or project management units, etc., produced by the decoder. This is the target result, decoded speech or programming language code that has been translated from the source language, ready for use or further processing as the case may be.

Add & norm layers within each transformer layer perform the task of normalizing and adding the outputs from the self-attention and feed-forward layers, ensuring that each layer's output is ready for the next layer without vanishing or exploding gradients. Feed forward′ networks within the transformer layers are standard neural network layers that process the data sequentially, applying necessary transformations to map the input state to the output. Attention mechanisms of the transformer, enable the model to focus on different parts of the input sequence when predicting each token of the output, thus effectively handling long-range dependencies in code.

This architecture uniquely addresses the challenges of, e.g., code translation, by leveraging the parallel processing capabilities of transformers, providing an attention-driven, context-aware model that maintains the syntactic and semantic integrity of the input during translation or processing using LLMs. The system 100 can be designed to facilitate prompt tuning, where task-specific prompts can be used to steer the model's output, as well as fine-tuning, where the model can be further refined with examples of the desired output to optimize performance for specific tasks. These detailed components work in concert within the transformer-based neural network to handle complex tasks with LLMs. Each portion contributes to the overall capability of the network to understand, maintain, and translate the intricate patterns and structures found in the input, providing a robust solution with high accuracy. This architecture is also adaptable for prompt tuning and fine-tuning, to offer a flexible approach to LLM training and application. The transformer architecture is designed to handle sequential data, making it particularly well-suited for natural language processing tasks, code translation, identifying tools APIs, modifying tool APIs, etc.

When integrated with an LLM, the transformer's architecture leverages the massive amount of parameters and the pre-training on extensive code corpora. The LLM, having learned patterns, structures, and the semantics of multiple programming languages, guides the transformer network's training process for the specific task of code translation. The LLM's pre-trained knowledge base significantly enhances the transformer's ability to understand and provide outputs for complex constructs by providing it with a broad understanding of programming language syntax and semantics. The combination of the transformer's structure with the LLM's extensive pre-training enables more accurate and contextually relevant outputs than would be possible with either component alone. The combination of transformer architecture of the AI agent 102 with an LLM creates a powerful model creating a virtual agent that can automatically host and facilitate in accordance with the embodiments of the present invention.

Referring to FIG. 9, a computing environment 900 contains an example of an environment for the execution of at least some of the computer code involved in performing the inventive methods, such as, hosting and facilitation of activities using an AI agent and an LLM in block 950. In addition to block 950, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid-state storage devices. Operating system 922 may take several forms, such as various known proprietary operating systems or open source Portable Operating System Interface-type operating systems that employ a kernel. The code included in block 950 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915. WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

Cloud computing services and/or microservices (not separately shown in FIG. 9): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, and laptops), through the Internet, to the provider's systems, and back. In some embodiments, cloud services can be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs (Application Programming Interfaces). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

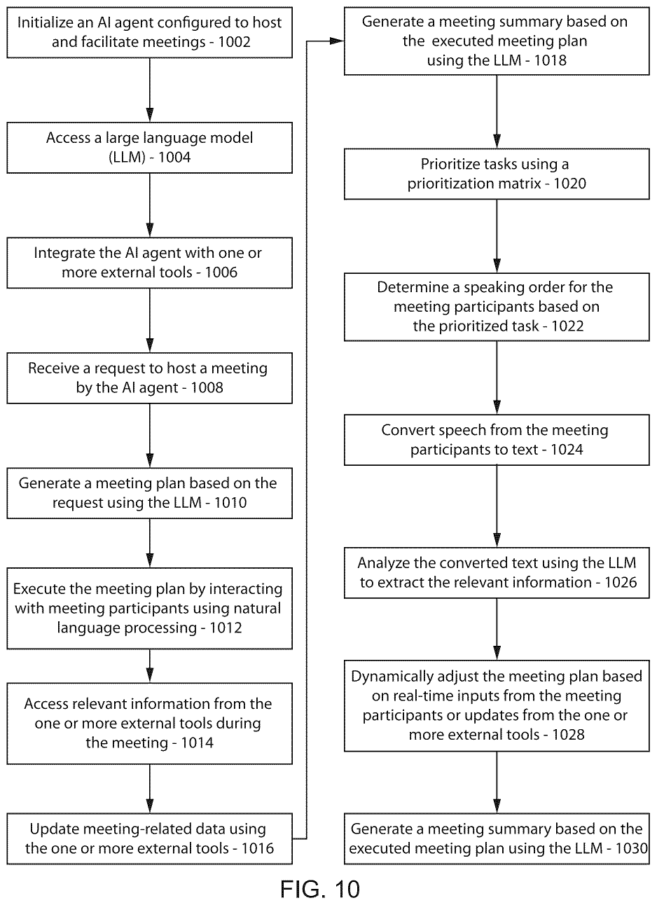

Referring to FIG. 10, a system/computer-implemented method for hosting and facilitating meetings and project management using a virtual agent that employs an LLM and external tools in accordance with embodiments of the present invention is shown and described. In block 1002, an artificial intelligence (AI) agent configured to host and facilitate meetings is initialized. The initialization process may involve several steps to prepare the AI agent for its role in meeting management and facilitation. The AI agent may be loaded into memory and its core functionalities activated. This may include setting up the agent's natural language processing capabilities, which enable it to understand and respond to human language inputs. The AI agent may also initialize its connection to the large language model (LLM) that it will use for more complex language tasks and decision-making processes. During initialization, the AI agent may establish connections with various external tools and APIs that it will use to perform its tasks. These may include, e.g., calendar applications for scheduling, project management software for task tracking, and communication platforms for sending notifications and updates to meeting participants. The AI agent may load predefined meeting templates and protocols that serve as a foundation for different types of meetings the AI agent can host. These templates may include structures for daily stand-ups, sprint planning sessions, or client presentations, each with its own set of rules and best practices. Additionally, the initialization process can include setting up the agent's knowledge base, which may include information about the organization, team members, ongoing projects, and historical meeting data. This knowledge base may be used by the AI agent to provide context-aware facilitation during meetings.

The AI agent may also initialize its learning modules, which allow the AI agent to adapt and improve its performance over time based on feedback and outcomes from previous meetings. This may involve setting up mechanisms for collecting and analyzing post-meeting feedback from participants. In some cases, the initialization process may include a configuration step where specific parameters are set according to the organization's preferences. This may include defining default meeting durations, preferred communication channels, or customizing the agent's language style to match a company culture. The AI agent may also set up its security protocols during initialization, ensuring that it has the necessary permissions to access relevant data while maintaining confidentiality and compliance with data protection regulations.

In block 1004, the AI agent is provided with access to a large language model (LLM). This can include establishing a secure connection between the AI agent and the LLM, which may be hosted on a separate server or cloud infrastructure. The LLM may be a pre-trained model capable of understanding and generating human-like text across a wide range of topics and contexts. The AI agent may be configured with appropriate authentication credentials to access the LLM's API. This may include API keys, tokens, or other secure authentication methods to ensure authorized and protected communication between the agent and the LLM. The AI agent may have the capability to select from multiple LLMs based on the specific requirements of the meeting or task at hand. For example, different LLMs may be optimized for various languages, technical domains, or conversation styles. The integration with the LLM may allow the AI agent to leverage advanced natural language processing capabilities. This may include understanding complex queries, generating coherent responses, summarizing discussions, and even translating between languages if needed.

The AI agent may be programmed to efficiently manage its interactions with the LLM, optimizing for factors such as response time, token usage, and cost-effectiveness. This can include implementing caching mechanisms for frequently requested information or batching multiple queries to reduce API calls. In some embodiments, the AI agent can have the ability to fine-tune or further train the LLM on domain-specific data relevant to the organization's needs. This may enhance the LLM's performance in understanding industry-specific terminology or company-specific jargon. The connection to the LLM may be designed with fallback mechanisms in place. If the primary LLM becomes unavailable, the AI agent may be able to switch to a backup model or operate with reduced capabilities to ensure continuity of service.

In block 1006, the AI agent is integrated with one or more external tools. This integration process may involve several steps to ensure seamless communication and data exchange between the AI agent and the external tools. The AI agent may establish API connections with various project management platforms, such as JIRA™, TRELLO™, or ASANA™. These connections may allow the AI agent to access and update task information, project timelines, and team assignments in real-time. Integration with calendar applications may be implemented to enable the AI agent to schedule meetings, check participant availability, and send meeting invitations automatically. The AI agent may also be connected to communication platforms such as, e.g., SLACK™, TEAMS™, or ZOOM™. This integration may allow the AI agent to send notifications, facilitate virtual meetings, and collect feedback through these channels.

In some embodiments, the AI agent may be integrated with document management systems. This integration may enable the AI agent to access, share, and update relevant documents during meetings or as part of project management tasks. The integration process may involve setting up authentication protocols to ensure secure access to these external tools. This may include implementing secure token-based authentication methods. Data synchronization mechanisms may be established to ensure that information remains consistent across all integrated platforms. This may involve setting up webhooks or periodic data syncing processes. The AI agent may be programmed with specific methods to interact with each external tool's API, allowing the AI agent to perform actions such as creating tasks, updating statuses, or retrieving information as needed. In some embodiments, the integration may include setting up error handling and logging systems to monitor the interactions between the AI agent and external tools, ensuring smooth operation and facilitating troubleshooting if issues arise. The integration process may also involve configuring how the AI agent interprets and acts upon data from different external tools, potentially using custom mappings or translation layers to standardize information across various platforms.

In block 1008, the AI agent receives and responds to a request to host a meeting. This request may come from any source, such as a team leader, project manager, or automated scheduling system. The request may be received through different channels, including email, chat applications, or dedicated project management tools. Upon receiving the request, the AI agent may parse and analyze the content to extract key information. This may include the meeting purpose, desired participants, preferred time slots, and any specific requirements or agenda items. The AI agent can use natural language processing techniques to understand the context and intent of the request. In some embodiments, the AI agent may prompt the requester for additional details if the initial request lacks sufficient information. This interaction may occur through a conversational interface, allowing the AI agent to gather all necessary data to effectively plan and host the meeting.

The AI agent may cross-reference the meeting request with existing schedules, project timelines, and team availability. This process can include querying integrated calendar systems and project management tools to identify potential conflicts or optimal meeting times.

Based on the extracted information and organizational policies, the AI agent may categorize the meeting type (e.g., daily stand-up, sprint planning, client presentation) and apply appropriate templates or protocols for that specific meeting category. The AI agent may also assess the urgency and importance of the meeting request, using predefined criteria or machine learning algorithms to prioritize among other tasks and meetings.

In some embodiments, the AI agent can have the capability to suggest alternative meeting formats or participants based on the meeting's purpose and available resources. For example, the AI agent can recommend a virtual meeting instead of an in-person gathering or suggest including additional team members with relevant expertise. The AI agent may log the meeting request in an internal system, creating a unique identifier for the meeting and initiating the subsequent steps in the meeting planning and hosting process. This can include updating relevant databases or task lists to reflect the new meeting in the overall project or team workflow.

In block 1010, the AI agent generates a meeting plan based on the request using the LLM. This process may involve several steps to create a comprehensive and tailored plan for the specific meeting. The AI agent may utilize the LLM to analyze the meeting request and extract information such as the meeting purpose, participants, and any specified agenda items. The LLM can help interpret natural language inputs and understand the context of the meeting request.

Using the extracted information, the AI agent may query its knowledge base and external tools to gather relevant data for the meeting. This may include retrieving project status updates, team member availability, and historical data from previous similar meetings. The AI agent may then use the LLM to generate a structured meeting agenda. This can include organizing discussion topics, allocating time slots for each agenda item, and suggesting relevant talking points or questions to guide the conversation. In some embodiments, the AI agent may use the LLM to predict potential discussion points or issues that may arise during the meeting based on historical data and current project status. This predictive capability may assist in preparing more comprehensive meeting materials. The meeting plan may include suggestions for meeting roles, such as facilitator, note-taker or timekeeper. The AI agent may use the LLM to analyze team dynamics and individual strengths to recommend optimal role assignments.

The AI agent may also use the LLM to generate pre-meeting materials, such as background information on discussion topics, relevant data visualizations, or summaries of previous related meetings. These materials may be tailored to the specific needs and preferences of the meeting participants. In some implementations, the AI agent may use the LLM to create multiple meeting plan options, each optimized for different priorities such as time efficiency, comprehensive discussion, or creative problem-solving. Once the meeting plan is generated, the AI agent can use the LLM to create personalized meeting invitations for each participant, including relevant details and any pre-meeting tasks or preparation requirements.

In block 1012, the AI agent executes the meeting plan by interacting with meeting participants using natural language processing. This can include a series of actions to facilitate the meeting effectively. The AI agent may initiate the meeting by greeting participants and providing a brief overview of the meeting agenda. Using natural language processing capabilities, the AI agent can interpret and respond to participants' queries or comments in real-time. During the meeting, the AI agent can guide the discussion according to the pre-determined agenda. The AI agent can use its natural language processing abilities to recognize when a topic has been adequately covered and prompt the group to move on to the next item. The AI agent can monitor the conversation flow and intervene when necessary. For example, the AI agent can redirect the discussion if it veers off-topic, or encourage participation from attendees who have been quiet.

In some embodiments, the AI agent can use sentiment analysis to gauge the mood of the meeting and adjust its communication style accordingly. For example, if tensions seem to be rising, the AI agent may adopt a more conciliatory tone. The AI agent may also use its natural language processing capabilities to capture and summarize key points in real-time. This may involve identifying action items, decisions made, and important discussion points as they occur.

In cases where the meeting involves remote participants, the AI agent may manage turn-taking and ensure that all attendees have an opportunity to contribute. The AI agent can use voice recognition to identify speakers and manage the flow of conversation in a virtual environment. The AI agent can also handle real-time language translation if needed, allowing participants who speak different languages to communicate effectively. Throughout the meeting, the AI agent can provide relevant information or data from integrated external tools as needed, presenting it in a way that is easy for participants to understand and discuss. At the end of each agenda item, the AI agent can summarize the discussion and confirm any decisions or action items with the group. This may help ensure that all participants are aligned before moving on to the next topic.

In block 1014, the AI agent accesses relevant information from the one or more external tools during the meeting. This process can include real-time data retrieval and integration to support the meeting's objectives and enhance decision-making. The AI agent can query, e.g., project management tools, to retrieve up-to-date task statuses, deadlines, and progress reports. This information can be presented to participants when discussing specific project elements or milestones. In some embodiments, the AI agent can access financial management systems to provide current budget information or expense reports relevant to the meeting topics. This can help inform discussions about resource allocation or project feasibility. The AI agent may interface with customer relationship management (CRM) tools to pull relevant client data, interaction history, or sales metrics when discussing client-related matters. This information may provide valuable context for strategic discussions or client-focused meetings. During technical meetings, the AI agent may access code repositories or development tools to retrieve information about recent code changes, bug reports, or feature implementations.

In block 1016, the AI agent updates meeting-related data using the one or more external tools. The real-time synchronization of information across various platforms can ensure all stakeholders have access to the most current data. The AI agent can update task management systems with new assignments, deadlines, or status changes that were discussed during the meeting. This may include creating new tasks, modifying existing ones, or marking tasks as complete based on the meeting outcomes. In some embodiments, the AI agent can update project timelines or milestones in real-time in project management tools to reflect any changes or decisions made during the meeting. This may help keep the overall project schedule aligned with the latest developments.

In block 1018, the AI agent generates a meeting summary based on the executed meeting plan using the LLM. This process may involve several steps to create a comprehensive and actionable summary of the meeting. The AI agent can analyze the entire meeting transcript, leveraging the LLM's natural language understanding capabilities to identify key discussion points, decisions, action items, and important context. This analysis can take into account the meeting agenda, participant contributions, and any data accessed from external tools during the meeting. Using the LLM, the AI agent can structure the summary in a logical and easily digestible format.

In some embodiments, the AI agent can use the LLM to generate personalized summaries for different participants or stakeholder groups, to emphasize information most relevant to their roles or responsibilities. This can help ensure that each team member receives the most pertinent information from the meeting. The AI agent can include direct quotes or paraphrased statements from participants when they are particularly impactful or representative of key decisions or viewpoints. The LLM can assist in selecting the relevant quotes and integrating them seamlessly into the summary. For action items identified during the meeting, the AI agent can use the LLM to clearly articulate each task, including details such as the responsible party, deadline, and any relevant context or resources needed for completion. In some embodiments, the AI agent can use the LLM to generate visual elements such as charts, graphs, or mind maps to represent complex information or relationships discussed during the meeting. These visual aids can help in conveying information more effectively to visual learners or for quick reference.

In block 1020, the AI agent can prioritize tasks using a prioritization matrix. This process can include analyzing aspects of each task to determine its relative importance and urgency within the project context. The AI agent can utilize different types of prioritization matrices, such as the Eisenhower Matrix or the RICE (Reach, Impact, Confidence, Effort) model, to categorize and rank tasks. These matrices may help in distinguishing between tasks that are urgent and important, important but not urgent, urgent but not important, and neither urgent nor important. The AI agent can use natural language processing to analyze task descriptions and extract key information relevant to prioritization. This may include identifying keywords that indicate urgency, importance, or complexity. In some embodiments, the AI agent can integrate historical data and past project performance metrics to inform its prioritization decisions.

In block 1022, the AI agent can determine a speaking order for the meeting participants based on the prioritized tasks. This can include analyzing the prioritized task list and matching the list with the relevant team members or stakeholders who are best suited to address each task. The AI agent can present the proposed speaking order to the participants for review and approval. This may allow for any necessary adjustments based on human insight or preferences not captured by the automated system. In some embodiments, the AI agent can dynamically adjust the speaking order during the meeting based on new information, emerging priorities, time constraints, etc. This can help ensure that the most important topics receive adequate attention within the allotted meeting time.

The AI agent can also provide visual cues or notifications to participants about their upcoming turn to speak, helping them prepare and maintain the flow of the meeting. This may be particularly useful in virtual meeting environments where non-verbal cues may be limited.

In block 1024, the AI agent may convert speech from the meeting participants to text. This process may involve utilizing advanced speech recognition technologies to accurately transcribe spoken words into written form in real-time. In some embodiments, the AI agent can utilize adaptive learning techniques to speech recognition accuracy over time, learning from corrections made by meeting participants and adapting to individual speaking patterns. The speech-to-text conversion can be performed in near real-time, with minimal latency between spoken words and their appearance as text. This enables immediate analysis and processing of the conversation content by other components of the AI agent system.

In block 1026, the AI agent can analyze the converted text using the LLM to extract relevant information. This process can include natural language processing. The AI agent may employ named entity recognition to identify and categorize key elements in the text, such as names of people, organizations, projects, dates, and numerical values. This may help in automatically tagging and organizing important information discussed during the meeting.

In block 1028, the AI agent can dynamically adjust the meeting plan based on real-time inputs from the meeting participants or updates from the one or more external tools. This adaptive approach can permit the AI agent to respond flexibly to changing circumstances and emerging needs during the meeting. The AI agent may continuously monitor participant interactions, analyzing verbal and non-verbal cues to assess engagement levels, comprehension, and areas of interest or concern. Based on this analysis, the AI agent may adjust the pace of the meeting, allocate more time to certain topics, or introduce additional discussion points as needed.

In block 1030, the AI agent using the LLM, can generate a meeting summary based on the executed meeting plan. The AI agent can analyze the entire meeting transcript, leveraging the LLM's natural language understanding capabilities to identify key discussion points, decisions, action items, and important context. This analysis may take into account the meeting agenda, participant contributions, and any data accessed from external tools during the meeting. In some embodiments, the AI agent can use the LLM to generate personalized summaries for different participants or stakeholder groups, emphasizing information most relevant to their roles or responsibilities. This tailored approach may help ensure that each team member receives the most pertinent information from the meeting.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
initializing an artificial intelligence (AI) agent configured to host and facilitate meetings;
integrating the AI agent with one or more external tools;
responsive to a request to host and facilitate a meeting, generating, by the AI agent, meeting details including a meeting topic, participants, and a start time;
generating, by the AI agent using a generative machine learning model, a meeting plan based on the request; and
executing, by the AI agent, the meeting plan by:
interacting with meeting participants using natural language processing,
accessing relevant information from the one or more external tools, and
updating meeting-related data using the one or more external tools; and
generating, by the AI agent using the generative machine learning model, a meeting summary based on an executed meeting plan.

2. The method of claim 1, further comprising invoking, by the AI agent, a tool to sort tasks using a priority matrix to categorize tasks based on urgency and importance.

3. The method of claim 1, wherein initializing the AI agent includes accessing a knowledge base and a set of rules.

4. The method of claim 1, wherein interacting with meeting participants includes managing participant interactions including:
designating a speaking order for participants based on tasks; and
monitoring discussion to determine if a speaker is off-topic or exceeding allotted speaking time.

5. The method of claim 4, further comprising interjecting, via the AI agent, a notification if the speaker is determined to be off-topic or exceeding allotted speaking time.

6. The method of claim 1, wherein the AI agent employs the generative machine learning model to generate responses to participant questions during the meeting.

7. The method of claim 6, wherein the generative machine learning model is integrated with external project management tools to access and update task information in real-time during the meeting.

8. A system comprising:
a processor set;
one or more computer-readable storage media; and
program instructions stored on the one or more computer-readable storage media to cause the processor set to perform operations comprising:
initializing an artificial intelligence (AI) agent configured to host and facilitate meetings;
integrating the AI agent with one or more external tools;
responsive to a request to host and facilitate a meeting, generating, by the AI agent, meeting details including a meeting topic, participants, and a start time;
generating, by the AI agent using a generative machine learning model, a meeting plan based on the request; and
executing, by the AI agent, the meeting plan by:
interacting with meeting participants using natural language processing,
accessing relevant information from the one or more external tools, and
updating meeting-related data using the one or more external tools; and
generating, by the AI agent using the generative machine learning model, a meeting summary based on an executed meeting plan.

9. The system of claim 8, further comprising invoking, by the AI agent, a tool to sort tasks using a priority matrix to categorize tasks based on urgency and importance.

10. The system of claim 8, wherein initializing the AI agent includes accessing a knowledge base and a set of rules.

11. The system of claim 8, wherein interacting with meeting participants includes managing participant interactions including:
designating a speaking order for participants based on tasks; and
monitoring discussion to determine if a speaker is off-topic or exceeding allotted speaking time.

12. The system of claim 11, further comprising interjecting, via the AI agent, a notification if the speaker is determined to be off-topic or exceeding allotted speaking time.

13. The system of claim 8, wherein the AI agent employs the generative machine learning model to generate responses to participant questions during the meeting.

14. The system of claim 13, wherein the generative machine learning model is integrated with external project management tools to access and update task information in real-time during the meeting.

15. The system of claim 8, wherein the operations further comprise:
translating code of the external tools using the generative machine learning model to serve functions requested by the AI agent.

16. A computer program product, comprising:
one or more computer-readable storage media; and
program instructions stored on the one or more computer-readable storage media to perform operations comprising:
initializing an artificial intelligence (AI) agent configured to host and facilitate meetings;
integrating the AI agent with one or more external tools;
responsive to a request to host and facilitate a meeting, generating, by the AI agent, meeting details including a meeting topic, participants, and a start time;
generating, by the AI agent using a generative machine learning model, a meeting plan based on the request; and
executing, by the AI agent, the meeting plan by:
interacting with meeting participants using natural language processing,
accessing relevant information from the one or more external tools, and
updating meeting-related data using the one or more external tools; and
generating, by the AI agent using the generative machine learning model, a meeting summary based on an executed meeting plan.

17. The computer program product of claim 16, wherein the operations further comprise invoking, by the AI agent, a tool to sort tasks using a priority matrix to categorize tasks based on urgency and importance.

18. The computer program product of claim 16, wherein initializing the AI agent includes accessing a knowledge base and a set of rules.

19. The computer program product of claim 16, wherein interacting with meeting participants includes managing participant interactions including:
designating a speaking order for participants based on tasks;
monitoring discussion to determine if a speaker is off-topic or exceeding allotted speaking time; and
interjecting, via the AI agent, a notification if the speaker is determined to be off-topic or exceeding allotted speaking time.

20. The computer program product of claim 16, wherein the generative machine learning model is integrated with external project management tools to access and update task information in real-time during the meeting.
